(19) United States
(12) Patent Application Publication
(10) Pub. No.: US 2005/0109578 A1
(43) Pub. Date: May 26, 2005

(54) Method for handling storage of coins of different values in magazine

(76) Inventors: Dominique Holtzer, Besancon (FR); Daniel Gautherot, Palise (FR)

Correspondence Address: SOFER & HAROUN LLP., 317 MADISON AVENUE, SUITE 910, NEW YORK, NY, 10017, US

(21) Appl. No.: 10/500,407

(22) PCT Filed: Dec. 5, 2002
(86) PCT No.: PCT/IB02/05145

(30) Foreign Application Priority Data
Dec. 24, 2001 (FR) 01/16893

(51) Int. Cl. G07D 7/00

(52) U.S. Cl. 194/302

(57) ABSTRACT

The invention concerns a method for managing storage of coins of different values in a magazine (28), comprising, for each coin to be stored: a step of receiving (100) and identifying the coin; a step of determining (116) whether the coin should be stored in the magazine (28) or in a chest (34). The invention is characterized in that it comprises a step which consists in periodically calculations (112) the maximum number of coins of each value capable of being stored in the magazine (28), and if the number of coins of some value as the received coin which are present in the magazine (28) is less than the maximum number of coins of said value capable of being stored in the magazine (28), then the coin is stored in the magazine (28), otherwise, the coin is stored in the chest (34).

The invention provides a method for handling storage of coins of different values.

More specifically, the invention provides a method for processing coins introduced into a coin tester of an automatic unit delivering goods or services, said coin tester containing a selector, a pre-receptacle, at least one reserve for recycling certain coins, a bowl for giving back the coins, and a safe, of the type including, for each coin:
a step for receiving and identifying the coin;
a step for temporarily storing the coin in the pre-receptacle;
a step for giving back the coin or a step for collecting the coin into the safe or into the reserve.
   Such a method finds a particularly advantageous application in the field of automatic dispensers of various objects or tickets which include an automated function for giving back the change.

Coin testers which are able to give back the change, are known. An example of such a coin tester is described in document FR-A-2 609 341. It includes a certain number of identical reserves, each including locations for each receiving a coin. It also includes a safe for collecting non-reusable coins. A system for handling the storage of coins redistributes the received coins either into the recycling reserves, a safe, in order to be reused for subsequently providing the change, and thus for spacing out the reloadings of the dispenser, or into a safe (also called cash register or moneybox).

Each reserve is in the shape of a rotary drum with a vertical axis and the reserves are coaxial and superimposed.

For this, a first reserve is used as a pre-receptacle and the coins introduced by the user are temporarily stored in the pre-receptacle until the end of the sale of the object. The upper pre-receptacle communicates with the other reserves for dispensing certain coins into the reserves for storing the coins definitively once the sold object has been delivered.

Thus, according to the implemented handling method in this document, all the introduced coins, regardless of their value, are deposited one by one into the consecutive locations of the pre-receptacle. When the amount of money is sufficient for paying for the service, the change is given back from other reserves. Next, the pre-receptacle is emptied into the different reserves, each reserve being dedicated to one single value of the coins.

When a reserve is full, the additional coins which it cannot receive are sent to the safe in which the coins which can no longer be reused for giving back the change, are stored “in bulk”.

Experience shows that certain reserves are rapidly exhausted, whereas other reserves are practically always full, notably those containing coins of values which are rarely given back, notably the coins with the highest values. It also appears that the values of the coins rarely given back may vary for a same type of dispenser according to the geographical location and the relevant customers.

Such a handling method now requires frequent interventions for reloading the magazine of the dispenser and monopolizes spaces which will never be emptied instead of using them differently in order to space out the reloadings of the magazine.

The object of the invention is to provide a handling method for storing coins of different values in a magazine acting as a recycling reserve which is able to vary its capacities for storing coins with a given value, notably in order to space out the manual loadings of the magazine.

For this purpose, the invention provides a method of the type described above, characterized in that the step for collecting the coin includes a step for determining whether the coin should be stored in the safe or in the reserve, according to conditions relating to the value of the coin and to the number of coins which have the same value as the new coin, which are present in the reserve.

According to other features of the invention:
the collection step consists of storing the coin in the safe, if the reserve is full, or if, according to the value of the coin, the number of coins which have the same value as the new coin and which are present in the reserve, is equal to a determined maximum number of coins;
the maximum number of coins with certain values is different from the maximum number of coins of certain other values;
for certain determined coin values, the maximum number of coins of this value is equal to the capacity of the reserve;
the maximum number of coins of each value is predetermined;
it includes a periodic step for calculating the maximum number of coins of each value able to be stored in the reserve, according to the amounts of coins of each value, received and taken out from the reserve during a first determined period, and according to the maximum number of coins of each value determined during the previous calculation step;
the step for storing the coin in the magazine consists of housing the coin in any empty location of the magazine;
the step for storing the coin in the magazine consists of housing the coin in an empty location of the magazine as determined according to the value of the coin;
the step for storing the coin in the magazine includes a step for storing the location and the value of the coin in memory;
the method includes a step for giving back the change which consists of transferring at least one coin from the magazine to a bowl distinct from the safe and magazine, the transfer step including a step for determining the value of the coin to be transferred, according to the maximum number of coins of each value as determined during the calculation step, and according to the number of coins of each value present in the magazine;
the method includes a periodic step with a longer period as said first period, for manually loading the magazine, so that it contains the calculated maximum number of coins of each value during the calculation step.

The invention provides, also relates to a device for storing coins of different values, applying a method according to any of the preceding claims, of the type including a selector, a magazine for receiving and recycling the introduced coins, a safe for storing the coins and a bowl for giving back the coins, characterized in that the magazine includes several locations, each location being able to receive a single coin of any value.

According to other features of the invention:
the device includes an electronic programmable control device;
the electronic control device includes means for identifying each location and for storing the contents of the location in memory;
the locations are mobile within the magazine, and in that the electronic control device includes means for detecting the position of each location;
the device includes means for identifying each coin and for determining the location associated with the coin.

Other features and advantages of the invention will become apparent upon reading the detailed description which follows for the understanding of which reference will be made to the appended figures among which:

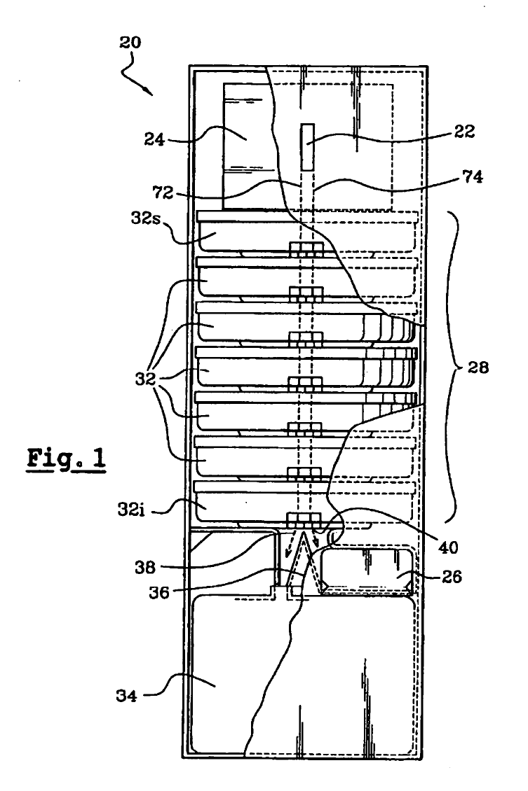

FIG. 1 is a schematic illustration of a coin tester applying a method according to the invention;

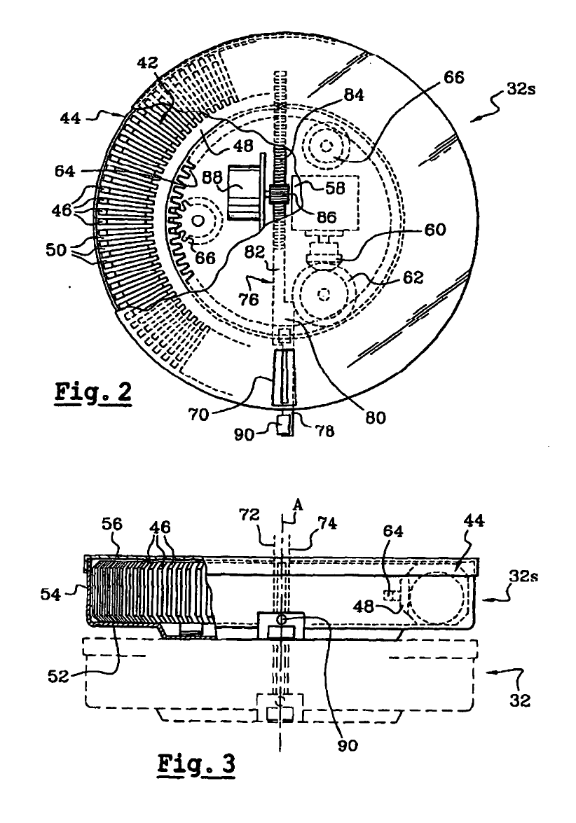

FIG. 2 is an axial view at a larger scale of the pre-receptacle of the coin tester illustrated in FIG. 1;

FIG. 3 is a radial view of the pre-receptacle illustrated in FIG. 2;

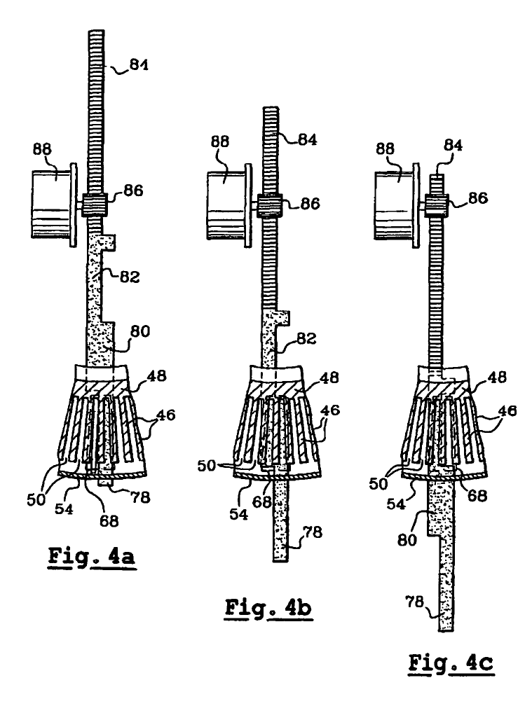

FIGS. 4a-4c are schematic illustrations at a larger scale of the pre-receptacle illustrated in FIG. 2, illustrating the different positions of the lock of the pre-receptacle;

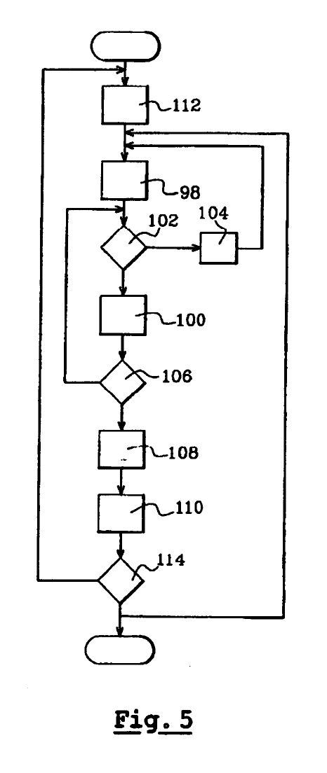

FIG. 5 is a diagram which schematically illustrates the general operation of the method according to the invention;

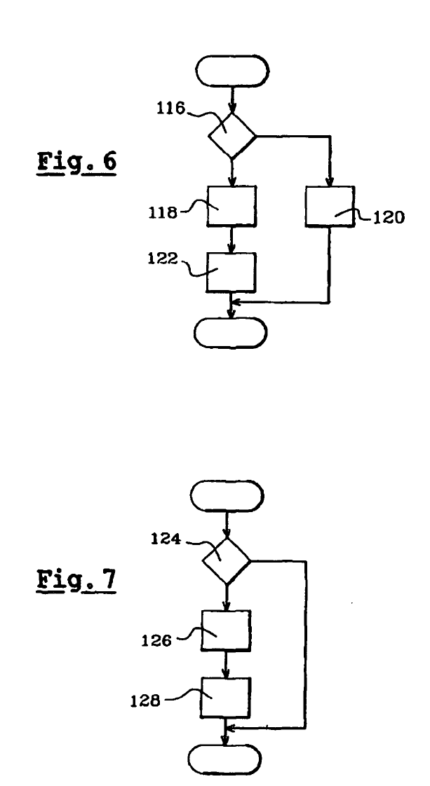

FIG. 6 is a diagram which schematically illustrates the operation of the storage step, according to the invention; and

FIG. 7 is a diagram which schematically illustrates the operation of the step for giving back the change, according to the invention.

In the description which follows, identical, similar, or like components will be designated by the same reference numbers.

A unit 20 which forms the coin tester portion of a conventional automatic dispenser (not shown) is illustrated in FIGS. 1-4. The dispenser may be a dispenser of any product, or any unit relative to a transaction which may be paid for by means of coins. It includes on its front, indications on the operation of the control buttons, notably a button for canceling the transaction, and display indicator lights (not shown).

As illustrated in FIG. 1, the coin tester 20 includes a slot 22 for introducing coins, located at the upper portion of the coin tester 20. A guiding channel (not shown) extends the slot 22 for guiding introduced coins towards a selector 24.

The selector 24 is of a known type and enables the different values of the coins to be distinguished. The selector 24 is connected to an electronic device (not shown) for controlling and handling the whole dispenser.

The electronic control device is programmable and is connected to the components of the coin tester 20, in order to apply the storage method which is programmed therein.

If a coin is not identified by the selector 24, the latter is directly sent into a bowl 26 located at the lower portion of the coin tester 20 which allows the user to retrieve the unidentified coin.

The coins identified by the selector 24 are then sent into a magazine 28 for storing coins.

The magazine 28 includes an upper reserve 32s forming a pre-receptacle which receives the coins identified by the selector 24, and reserves 32 positioned below the pre-receptacle 32s which are six in number here.

The pre-receptacle 32s and the lower reserves 32 are of identical structure, and are of a circular annular shape, superimposed and coaxial with a vertical axis A.

The bowl 26 on the one hand and a safe 34 on the other hand are found under the last lower reserve 32i, i.e. the one which is located the lowest.

A guiding unit 36 enables the coins to be sent to the bowl 26 or to the safe 34, according to their exit point 38 or 40 of the last reserve 32i.

FIGS. 2 and 3 illustrate the pre-receptacle 32s, however the latter is of a structure identical with reserve 32 and it is understood that the following description may also be applied to any of the reserves 32.

The pre-receptacle 32s includes a loader 42 positioned in a fixed cassette 44.

The loader 42 comprises a circular annular crown with a vertical axis A including radial or radiant vertical partitions 46, connected to each other at their internal radial ends by a connecting ring 48. The radiant partitions 46 thereby delimit locations 50 with open upper and lower faces.

The cassette 44 includes a horizontal circular annular bottom 52, an external annular wall 54 and a circular annular lid 56. The pre-receptacle 32s also includes means for driving the loader 42 into rotation around its axis A.

These means include a motor 58 of the stepping type which bears on its output shaft, a first cogwheel 60 which engages with a second cogwheel 62 which cooperates with a toothed crown 64 integral with the loader 42 for driving the latter into rotation.

Two idly mounted cogwheels 66 engage with the crown 64 to provide centering of the loader 42 around the A axis.

The bottom 52 of the cassette 44 includes an aperture 68 (FIG. 4) located under the locations 50, and the lid 56 itself also includes an aperture 70 located vertically above the aperture 68 of the bottom 52 of the cassette 44.

Both of these apertures 68, 70 have a circumferential width for clearing the upper and lower open faces of two consecutive locations 50.

The apertures 68, 70 of the pre-receptacle 32s and of all the reserves 32 are all aligned vertically and the motors 58 of each loader are controlled by the control device of the dispenser so that two consecutive locations 50 are located opposite to the apertures 68, 70, thereby forming two vertical channels 72, 74 crossing the reserves 32 and the pre-receptacle 32s.

Moreover, the apertures 68, 70 are positioned so that the channels 72, 74 each open through an exit point 38, 40 of the last reserve 32i, a first channel 72 opening onto the safe 34 and the second channel 74 opening onto the bowl 26.

Thus, by rotating the loader of one of the reserves 32 or of the pre-receptacle 32s, it is possible to bring the desired coin vertically above either one of the channels 72, 74 so that it may fall into the safe 34, into the bowl 26, or for transferring it to a reserve 32 located at a lower level and for which the aperture 68 of the bottom 52 of the cassette is closed by a lock.

For this purpose, each cassette 44 includes a lock 76 illustrated at a large scale in FIGS. 4a-4c. The lock is slidably mounted along a horizontal radial direction relatively to the cassette 44 between a first position (FIG. 4a) in which it seals off the portion of the aperture 68 corresponding to the second channel 74, a second position (FIG. 4b) in which it seals off the whole aperture 68, and a third position (FIG. 4c) in which it seals off the portion of the aperture 68 corresponding to the first channel 72.

The lock 76 is a horizontal planar component which extends radially outwards and the external radial end of which 78 extends angularly so as to seal off the portion of the aperture 68 corresponding to the second channel 74 when the lock 76 is in its first position.

The intermediate radial portion 80 of the lock 76 extends angularly so as to seal off the whole aperture 68 when the lock 76 is in its second position, and the internal radial end 82 of the lock 76 extends angularly so as to seal off the portion of the aperture 86 corresponding to the first channel 72 when the lock 76 is its third position.

In order to allow displacement of the lock 76, its internal radial end 82 is extended with a rack 84 which radially extends towards the inside of the cassette 44 and which engages with the cogwheel 86 of a second driving motor 88 fixed to the cassette 44.

Each housing 50 closed at its lower face is able to receive, in a vertical and radial position, any of the coins able to be accepted by the selector 24.

The pre-receptacle 32s also includes a sensor 90 of the position of the loader 42 which is connected to the electronic control device in order to know the exact angular position of each location 50 relatively to a fixed reference.

The sensor 90 is a proximity effect sensor; it sends an electrical pulse to the electronic command device at each passage of the external radial end of a partition 46, i.e. when the loader 48 is displaced by one location 50. Moreover, the direction of rotation of the loader is determined by the electronic control device. Thus, by counting the number of pulses which it receives and according to the direction of rotation of the loader 48, the electronic command device is capable of determining the angular displacement of each location 50, it may therefore determine the angular position of each location.

Further, when a coin is received in a location 50 or when a coin leaves the location in which it is housed, the electronic control device stores in memory the new status of the location 50, i.e. the value of the new coin which it houses, or if it is empty once again.

With reference to the diagrams illustrated in FIGS. 5-7, the handling method of the coin tester 20 which is handled by the electronic control device of the dispenser will be described.

For a better understanding of the description of the method which will follow, the coin tester 20 is in an initial state in which all the locations 50 of the pre-receptacle 32s are empty, certain locations of the reserves 32 are empty and the others each contain only one coin.

Further, the loaders 42 of each reserve 32 are positioned so that two empty locations 50 are positioned in both channels 72, 74, and the locks of the pre-receptacle and of all the reserves are in their third position, (illustrated in FIG. 4c) in which they only seal off the first channel 72. The electronic control device has stored in memory the angular position of each location 50 and the value of the coin which it contains or the fact that this location 50 is empty.

The method includes an initial step 98 for defining the sum to be received subsequent to the selection of an object desired by the user, and the dispenser's lights display the amount of money to be provided for the requested service.

The definition step 98 is followed by a step 102 for testing the action of the user, which depends on the action by the user on a canceling button of the dispenser or on the insertion of a coin into the slot 22. Thus, if the user presses the canceling button, the testing step 102 is followed by a step 104 for giving back all the coins which have been inserted by the user, which consists of having the loader 42 of the pre-receptacle 32s pivot in the anticlockwise direction in order to bring all the coins which have been introduced by the user and stored in the pre-receptacle 32s into the second channel 74 in order to transfer them to the bowl 26.

If the user inserts a coin in the slot 22, the testing step 102 is followed by a step 100 for receiving each coin introduced by the user. This receiving step 100 is performed by the selector 24 and it consists of recognizing the received coin in order to determine its value. If the coin is not identified, it is directly sent to the bowl 26 through the second channel 74.

When the introduced coin is identified, it is sent to the pre-receptacle 32s through the first channel 72. Since the lock 26 of the pre-receptacle 32s is in its third position, it seals off the first channel 72. Therefore, the coin is stopped by the lock and stored in a location 50 of the pre-receptacle 32s.

After receiving each identified coin, the loader 42 of the pre-receptacle 32s rotates clockwise by one step, with reference to FIG. 1, in order to present the next empty location 50 opposite to the first channel 72.

Simultaneously, the electronic control device stores in memory the “number” of the location 50 and the value of the coin which has just been received and stored in this location 50.

The receiving step 100 is followed by a step for calculating the received amount 106 which consists of adding the values of all the coins present in the pre-receptacle 32s.

If the received amount is less than the amount to be received, the method loops so that the step 106 for calculating the received amount is followed by the testing step 102. If the amount is sufficient for paying the service, i.e. it is larger than or equal to the amount to be received, the step 106 for calculating the received amount is followed by a step 108 for giving back the change, which consists of giving back to the user an amount of money corresponding to the difference between the received amount and the amount to be received for paying the object. This step 108 for giving back the change will be described later on.

The step 108 for giving back the change is followed by a step 110 for collecting the coins received and stored in the pre-receptacle 32s, which consists of determining if each received coin which is present in the pre-receptacle, should be stored in the magazine 28 or in the safe 34, and this according to the coins already present in the magazine 28, and according to the programming of the electronic control device.

The sequence of these steps is repeated for each new transaction throughout the operation of the dispenser.

According to the teachings of the invention, the method includes a periodic step 112 for calculating the maximum number of coins of each value, able to be stored in the magazine 28.

With this calculation step 112, the number of locations 50 dedicated to a value of coins may be varied so that there is only a small number of coins which remain unused, and notably in order to space out the loadings of the magazine with new coins.

The calculation step 112 consists of determining the values of coins which are likely to be exhausted rapidly, and of increasing the number of locations 50 dedicated to these coin values, and conversely, of reducing the number of locations 50 dedicated to the values of coins for which the majority of locations 50 dedicated to them are likely to be always full. The calculated numbers are determined so that their sum does not exceed the storage capacity of the coin tester 20.

Thus, for the values of coins which are introduced by the different successive users, more frequently than they are given back (this is notably the case of the coins with high values), the number of locations dedicated to these values is reduced.

For the values of coins which are introduced less frequently than they are given back, the number of locations dedicated to these values will be increased. And for the values of coins which are introduced as frequently as they are given back, the number of locations dedicated to these values will also be reduced.

According to an alternative of the invention, for the coins of certain values which are introduced less frequently than they are given back, these coins are always collected in the magazine 28, within the limit of the capacity of the coin tester 20. According to this alternative, the maximum number of coins of these values is then the capacity of the coin tester 20, the sum of all the maximum numbers is now no longer limited.

According to another alternative of the invention, the method no longer includes a calculation step 112, the maximum numbers of coins of each value are then predetermined by programming the coin tester 20 upon its installation on site.

In order to know if a coin value is received more frequently or less frequently than it is given back, the electronic control device stores in memory the amounts of coins of each value which are received and which are given back during the different transactions which occur during a period. The calculation is performed according to this history and also according to the numbers determined during the previous calculation step 112.

The length of the period is determined so that a sufficient number of transactions may occur between two calculation steps 112. Therefore, this may either be a period of time or a number of transactions.

For this, the method includes a testing step 114 which occurs after the collection step 110 and which checks whether the period of the calculation step 112 has elapsed or not. If the period has not elapsed, testing step 114 is followed by a new transaction, i.e. by step 98 for defining the amount to be received. On the other hand, if the period has elapsed, testing step 114 is followed by a new calculation step 112.

The step 110 for collecting a coin from the pre-receptacle 32s is illustrated in FIG. 6. When the pre-receptacle 32s contains several coins, this step is repeated as many times as there are coins to be transferred or stored.

Since the electronic control device knows the location 50 and the value of each coin, it may know the number of coins of each value, which are present in the magazine 28.

For each new coin to be stored in the magazine 28, the connection step 110 includes a step 116 for determining whether the coin should be stored in the magazine 28 or in the safe 34. This determination step 116 consists of comparing the number of coins present in the magazine 28 and which have the same value as the new coin, to the maximum number of coins of the same value able to be stored in the magazine, which was determined during the calculation step 112.

If the number of coins which have the same value as the new received coins and which are present in the magazine 28 is less than the maximum number of coins of the same value able to be stored in the magazine (as determined during the calculation step 112), then the determination step 116 is followed by a step 118 for storing the coin in the magazine 28, or else, the determination step 116 is followed by a step 120 for storing the coin in the safe 34.

The step 118 for storing the coin in the magazine 28 consists of transferring the coin from the pre-receptacle 32s to an empty location 50 of one of the following reserves 32 of the magazine 28.

According to the invention, each location 50 is able to receive a coin with any value. Thus, the empty location 50 which receives the new coin, is any location 50 of the magazine, as for example the location 50 of the reserve 32 located the nearest to the pre-receptacle 32s and which is not completely full.

According to an alternative of the invention, the empty location 50 which receives the coin is determined according to the value of the coin, for example in order to group the coins of same value and facilitate maintenance of the coin tester 20.

For transferring the coin from the pre-receptacle 32s into the empty location 50, the locks 76 of the pre-receptacle 32s and those of the reserves 32 other than the one including the location 50 which will receive the coin, are first displaced towards their first position, whereas the lock of the reserve 32 including the location 50 which will receive the coin, is displaced towards its second position. Next, the loader 42 which includes this location 50, is set into rotation until the location 50 is located in the first channel 72.

The loader 42 of the pre-receptacle 32s is set into rotation so that the coin is in the first channel 72, thereby releasing the coin which thus falls into location 50. Finally, the loader 42 of the reserve which has just received the coin is set into rotation so as to move back to its initial position, and all the locks 76 are displaced towards their initial position.

The step 118 for storing the coin in the magazine 28 is followed by a step 122 for storing in memory the location 50 which has just received the coin and the value of this coin, so that it is possible to know for each location 50 either the value of the coin which it contains or else, for each coin value, which are the locations which contain a coin of this value.

The step 120 for storing the coin in the safe 34 consists of transferring the coin from the pre-receptacle 32s towards the safe 34. For this, all the locks 76 of the pre-receptacle 32s and of the reserves 32 are displaced towards their first position, thereby opening the first channel 72 entirely, which opens onto the safe 34. Next, the loader of the pre-receptacle is set into rotation, so that the coin is in the first channel 72. As this channel is free, the coin directly falls into the safe 34.

This connection step 110 is repeated as many times as there are coins in the pre-receptacle 32s, so as to empty it entirely.

According to another aspect of the invention, the maximum numbers of coins of each value, calculated during the calculation step 112, are used during the step 108 for giving back the change.

The step 108 for giving back the change is illustrated in FIG. 7, and it includes a first step 124 for calculating the amount to be given back, which consists of subtracting the amount to be received from the amount introduced by the user. If the amount to be given back is zero, there will be no money to give back to the user, the step 108 for giving back change is then completed. Otherwise, step 124 for calculating the amount to be given back is followed by a step 126 for determining the distribution of the coins to be given back, i.e. the coins to be transferred from the magazine 28 to the bowl 26.

According to this aspect of the invention, during step 126 for determining the coins to be given back, the electronic control device uses the maximum numbers of coins of each value as determined during the calculation step 112, and the number of coins of each value present in the magazine 28.

Preferably, the coins to be given back are determined so as to give back in priority those for which the number inside the magazine 28 is close to the maximum number of coins determined during the calculation step 112.

Thus, the coins which are in a small number inside the magazine 28, relatively to the maximum number as determined during the calculation step 112, will be given back the less frequently as possible, in order to delay the shortage of coins of this value.

It is now possible to keep coins of each value in the magazine 28 as long as possible in order to space out the manual loadings of the magazine 28.

According to an alternative of the invention, the coins to be given back are determined so that coins of lower value are given back in priority. If there are not enough coins of this value, coins of the higher value will then be given back in priority.

The step for giving back the change consists of transferring the coin(s) determined during the determination step 126 from magazine 28 to the bowl 26, and this transfer occurs coin by coin.

For transferring a coin, the lock 76 of the cassette 44 which contains the coin, is displaced towards its second position in order to seal off both channels 72, 74.

Next, the loader 42 which contains the coin to be transferred is set into rotation until the coin is in the second channel 74, the associated lock 76 being then displaced towards its third position so as to free the coin which falls into the bowl 26, and then it is again displaced towards the second position so that the loader 42 may move back to its initial position. The lock 76 of the pre-receptacle 32s is then displaced towards its first position.

Finally, the location 50 which contained the coin which has just been given back, is stored in memory as being again an empty location 50 able to receive a possible new coin inserted by a user.

According to another aspect of the invention, the handling method includes a step for loading the magazine 28 (not shown) with coins, which consists of filling all the locations of the magazine so that the latter contains the maximum number of coins of each value, as calculated during the calculation step 112.

This loading step is periodic and its period is longer than the period of the calculation step 112. As the method is aimed at spacing out reloadings of the magazine 28, the loading step in this case, may be determined by the electronic control device so that the loading occurs when the number of coins of a value reaches a predetermined minimum value.

The reloading of the magazine then consists of introducing new coins, the number of these new coins being determined from the maximum numbers of coins of each value as determined during the calculation step 112.

For the operation of the method, the electronic control device needs to know the location 50 and the value of each new coin. So, it is not possible to manually introduce a coin without storing in memory the location 50 in which it is stored and its value. Thus, the loading is performed by introducing the new coins through the slot 22, one by one, the selector then recognizes the value of the coin which is then directly sent to an empty location 50 of a reserve 32, without being stored in the pre-receptacle 32s, and the location 50 and the value of the coin are then stored in memory.

For the loading, the coin tester 20 may display the value of coins which are to be loaded, for example by means of indicator lights or other display means of the dispenser.

An example illustrating the operation of the method according to the invention will be described in the following. In this example, the coin tester 20 may receive coins of 20, 10, 5, 2, 1 and 0.50 fiduciary units (FUs), and its capacity is 100 coins. The object of the transaction has a value of 8 FUs.

From the previous transactions, it appears that the most frequently received coins are those of 10 FUs, then those of 5 and 20 FUs, then those of 2 FUs, those of 1 FU, and finally those of 0.50 FU.

The coins of 20 FUs are the coins with the maximum value, it is therefore not possible that change given back includes a coin of this value. This is why it proves to be unnecessary to store coins of this value in the magazine 28, the maximum number of 20 FU coins is then zero.

Coins of 10 and 5 FUs are the coins with the most important values and they are thereby received the most frequently, there is little likelihood that change given back includes a coin of these values. This is why the maximum number of coins of these values is small, for example it is four for each value. This maximum number for the coins of 10 and 5 FUs will preferably be constant.

The coins of 2 FUs are the coins which are globally given back as frequently as they are received. The maximum number of coins of this value is then determined during calculation step 112 so there is no shortage in 2 FU coins.

The 1 and 0.50 FU coins are the coins which are the less frequently received and the most frequently given back. This is why the maximum numbers of coins of these values are not limited.

To pay for the transaction, the user inserts a 10 FU coin into slot 22. The amount to be given back is then 2 FUs, which may be obtained from coins of 2, 1 and 0.50 FU.

According to the invention, the coin tester will give back in priority the coins with the lowest value, i.e. 0.50 FU coins, four in number here. If it does not contain a sufficient number of 0.50 FU coins, it will give back a coin of 1 FU and two of 0.50 FU. Thus, solely, few 2 FU coins will be given back.

Next, the received coin will be stored in one of the reserves 32 if less than two coins of 10 FUs are already present in the different reserves 32, otherwise the coin will be stored in the safe.

It will be understood that simple order inversions may form alternative embodiments of the invention. For example, the step 98 for defining the amount to be received may be preceded by the receiving step 100. The definition of the amount to be received is then the validation of the transaction.

Such a method utilizes the fact that no location 50 of the reserves 32 is dedicated to a determined coin value. Thus, it is possible to have different maximum numbers of coins for different coin values.

Such a method provides the handling of the storage of the received coins and those owed to different users in order to space out the coin replenishments, indeed if the conditions allow this, to suppress the replenishments or reloadings and therefore to make the coin tester self-contained. This may particularly be advantageous for payment units, for example those for parking spaces, which moreover do not need to be replenished with goods and which do not require many human interventions.

Furthermore, as consuming and paying habits of different users vary according to the implantation site of the unit, with such a handling method, it is possible to adapt the coin tester 20 without there being any need for carrying out any prior programming, itself dependent on a statistical study.

The invention is not limited to the storage of coins with a fiduciary value, but it also finds application to like objects such as for example tokens, notably game tokens.

1. A method for processing coins introduced in a coin tester of an automatic unit delivering goods or services, said coin tester containing a selector, a pre-receptacle, at least one reserve for recycling certain coins, including several locations, each location being able to receive only one coin of any value, a bowl for giving back the coins, and a safe, of the type including, for each introduced coin, said method comprising the steps of:
a step for receiving and identifying the coin;
a step for temporarily storing the coin in the pre-receptacle;
a step for giving back the coin or a step for collecting the coin into the safe or into the reserve,
wherein the step for collecting the coin includes a step for determining whether the coin should be stored in the safe or in the reserve, according to conditions relating to the value of the coin, and to the number of coins which have the same value as the new coin, which are present in the reserve.

2. The method according to claim 1, wherein the collection step includes storing the coin in the safe, if the reserve is full, or if, according to the value of coin, the number of coins which have the same value as the new coin and which are present in the reserve, is equal to a determined maximum number of coins.

3. The processing method according to claim 2, wherein the maximum number of coins of certain values is different from the maximum number of coins of certain other values.

4. The method according to claim 3, wherein in that for certain determined coin values the maximum number of coins of this value is equal to the capacity of the reserve.

5. The method according to claim 4, wherein the maximum number of coins of each value is predetermined.

6. The method according to claim 1; further comprising a periodic step for calculating the maximum number of coins of each value able to be stored in the reserve, according to the amounts of coins of each value received and taken out from the reserve during a first determined period, and according to the maximum number of coins of each value as determined during the preceding calculation step

7. The method according to claim 1, wherein the step for collecting the coin into the reserve includes storing the coin in any empty location of the reserve.

8. The method according to claim 1, wherein the step for collecting the coin into the reserve includes storing the coin in a determined empty location of the reserve according to the value of the coin.

9. The method according to claim 1, wherein the step for collecting the coin by storing it in the reserve, includes a step for storing in memory the location and the value of the coin.

10. The method according to claim 1, having a step for giving back the change which consists of transferring at least one coin from the reserve to a bowl distinct from the safe and from the reserve, wherein the step for giving back the change includes a step for determining the value of the coin to be transferred, according to the maximum number of coins of each value, and according to the number of coins of each value present in the reserve.

11. The method according to claim 1, further comprising a periodic step, with a longer period as said first period, for manually loading the reserve, so that it contains the maximum number of coins of each value.

12. A device for storing coins of different values, implementing a method according to claim 1, said device comprising: a selector, a magazine for receiving and recycling the introduced coins, a safe for storing coins, and a bowl for giving back the coins,
wherein the magazine includes a pre-receptacle and at least one reserve for recycling certain coins, said reserve including several locations, each location being able to receive a single coin of any value.

13. The device according to claim 12, further comprising an electronic programmable control device.

14. The device according to claim 13, wherein the electronic control device further comprises a means for identifying each location and for storing in memory the contents of the location.

15. The device according to claim 14, wherein the locations are mobile within the magazine and that the electronic control device includes means for detecting the position of each location.

16. The method according to claim 8, wherein the coin tester employed in said method further includes means for identifying each coin and for determining the location associated with the coin.

17. The device according to claim 12, wherein the magazine includes a pre-receptacle and a reserve.
